(19) United States
(12) Patent Application Publication
(10) Pub. No.: US 2014/0145672 A1
(43) Pub. Date: May 29, 2014

(54) POWER STRIP

(71) Applicants: HONG FU JIN PRECISION INDUSTRY (SHENZHEN) CO., LT, Shenzhen (CN); HON HAI PRECISION INDUSTRY CO., LTD., New Taipei (TW)

(72) Inventor: WU ZHOU, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/706,335

(22) Filed: Dec. 5, 2012

(30) Foreign Application Priority Data
Nov. 26, 2012 (CN) 201210485781.9

(51) Int. Cl. H02J 7/00

(52) U.S. Cl. CPC H02J 7/00
USPC 320/107

(57) ABSTRACT

A power strip includes a main body including a circuitry, a pair of connecting portions, a switch, and a sliding member. The main body defines a receiving room bound by a bottom wall, a first end wall, and a second end wall opposite to the first wall. The connecting portions are mounted to the first end wall. Each connecting portion includes a pin rested on the bottom wall. The sliding member is slidably mounted to the main body. The switch is mounted to the second end wall. The sliding member sandwiches a battery together with the first end wall. The sliding member is operable to slide toward the second end wall to push the switch to turn the power off, and is operable to slide toward the second end wall again to push the switch to turn the power on.

### BACKGROUND

1. Technical Field

The present disclosure relates to a power strip.

2. Description of Related Art

Chargers are used to charge batteries of mobile phones and many other devices. However, when a battery needs to be charged, some people often spend quite amount of time finding the charger, which is undesirable. Furthermore, when people need to go out for a long time, people need to take the charger with him. A novel power strip which can charge batteries for mobile devices is thus needed to solve the above-mentioned issues.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an exemplary embodiment of a power strip, together with a battery.

FIG. 2 is an enlarged view of the circled portion II of FIG. 1.

FIG. 3 is an assembled, isometric view of the power strip of FIG. 1.

FIG. 4 is cross-sectional view of FIG. 3, taken along the line IV-IV.

FIG. 5 is an assemble isometric view of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

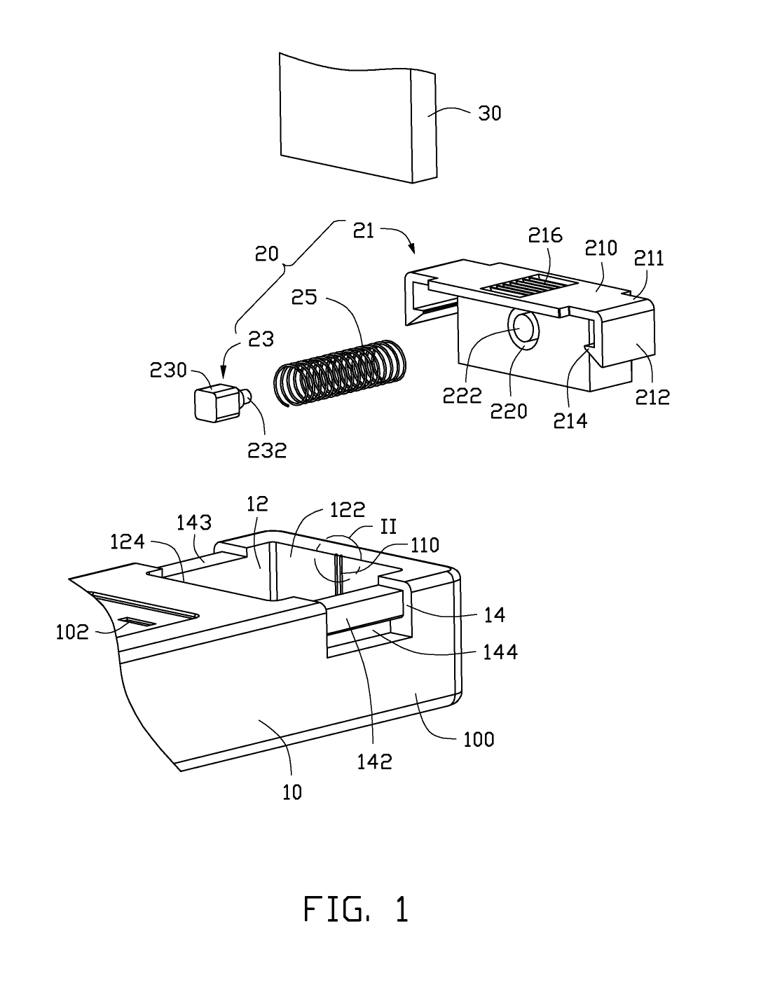

FIGS. 1, 2, and 4 show an exemplary embodiment of a power strip. The power strip is provided for charging a battery 30 of a portable electronic device, such as a mobile phone. The power strip includes a main body 10 forming a plurality of power outlets 102 in which a plurality of plugs can be engaged and contain circuitry, a fixing member 20, and two connecting portions 110.

The main body 10 defines a receiving room 12 in a top surface. The receiving room 12 is bound by a bottom wall 120, two opposite sidewalls 100, and two opposite end walls 122 and 124. A recess 14 is defined in an outer surface of each sidewall 100, between the end walls 122 and 124. A cutout 143 communicating with the receiving room 12 and a corresponding one of the recesses 14 is defined in a top of each of the sidewalls 100. An engaging hole 144 is defined in a wall 142 of each recess 14 parallel to the outer surfaces of the sidewalls 100. Two spaced slots 126 each having a semicircular cross-section are defined in the end wall 122, perpendicular to the bottom wall 120 and extending through the top surface of the main body 10 and the bottom wall 120.

The fixing member 20 includes a sliding member 21, a switch 23, and a spring 25.

The sliding member 21 includes a main portion 210, two extension portions 211 extending out from opposite ends of an upper portion of the main portion 210, and two arms 212 perpendicularly extending down from distal ends of the extension portions 211. A wedged-shaped projection 214 protrudes from an inner surface of each arm 212 facing the other arm 212. An antiskid portion 216 is formed on a top surface of the main portion 210. A receiving hole 220 having a blind end is defined in a side of the main portion 210. A pole 222 protrudes out from the blind end of the receiving hole 220.

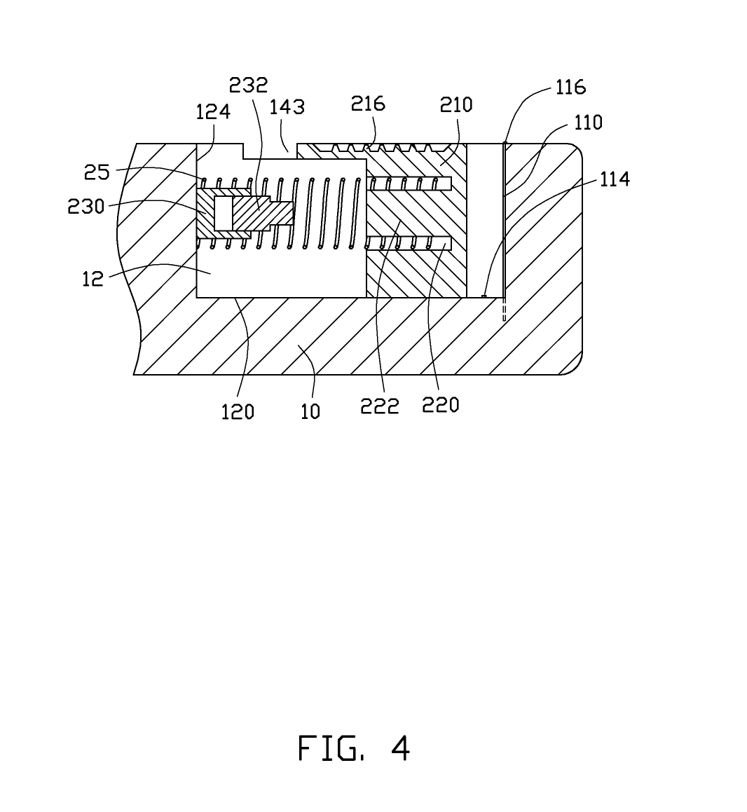

FIG. 4 shows that the switch 23 is a power switch. The switch 23 includes a head 230 mounted to the end wall 124, and a trigger 232 extending from the head 230. The trigger 232 can be pushed into the head 230 to switch off the circuitry of the power strip from the power supply outside (not shown), thereby turning power off, and be pushed again to extend out of the head 230 to connect the circuitry of the power strip to the power supply outside, thereby turning power on.

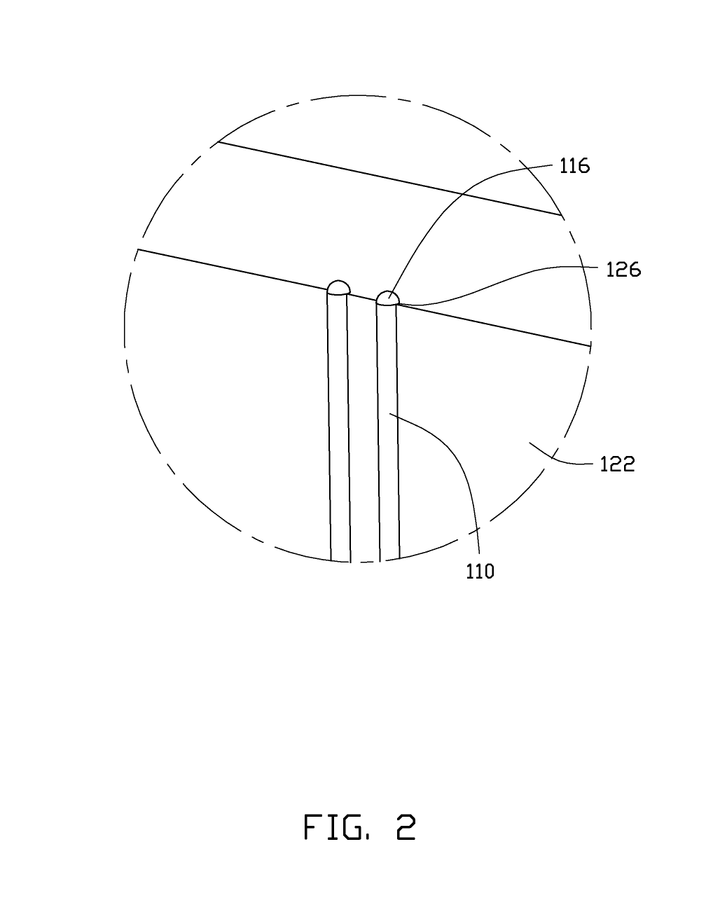

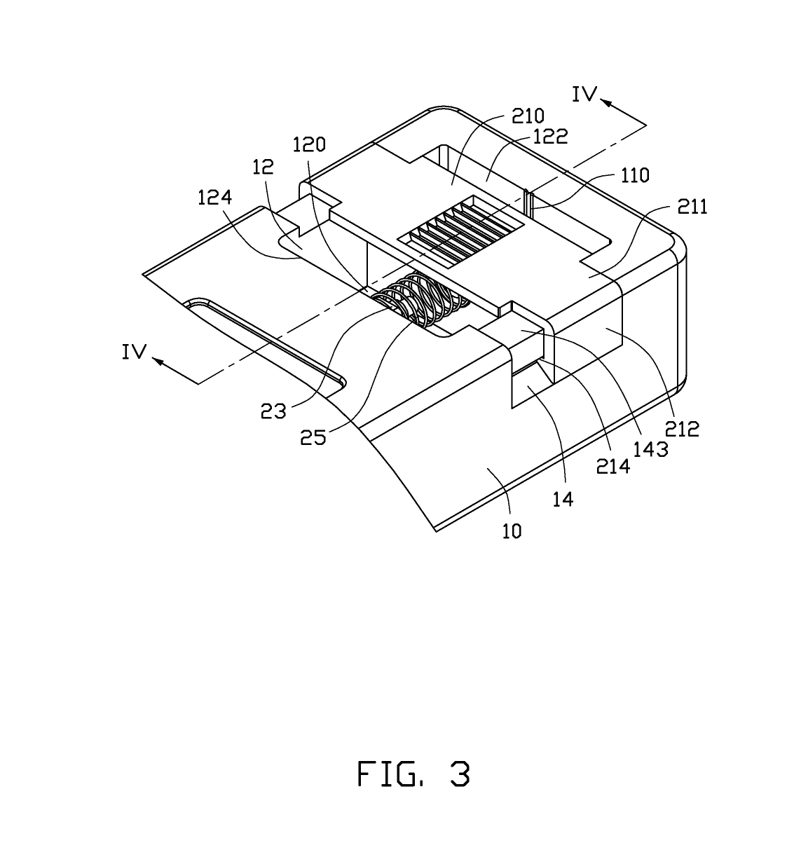

FIGS. 2 to 4 show that each connecting portion 110 is pivotably received in one of the slots 126. A bottom end of the connecting portion 110 extends into the bottom wall 120 to be connected to the circuitry of the power strip. A pin 114 extends from each connecting portion 110 and rests on the bottom wall 120. An insulation portion 116 is mounted to a top end of each connecting portion 110, and is located on the top surface of the main body 10.

In assembly, the extension portions 211 are slidably received in the cutouts 143, the arms 212 are slidably received in the corresponding recesses 14, and the projections 214 are slidably engaged in the corresponding engaging holes 144, thereby slidably mounting the sliding member 21 between the end walls 122 and 124. A first end of the spring 25 is fitted around the switch 23 and abuts against the end wall 124, and a second of the spring 25 opposite to the first end is fitted around the pole 222 and received in the receiving hole 220. Therefore, the spring 25 is sandwiched between the end wall 124 and the sliding member 21.

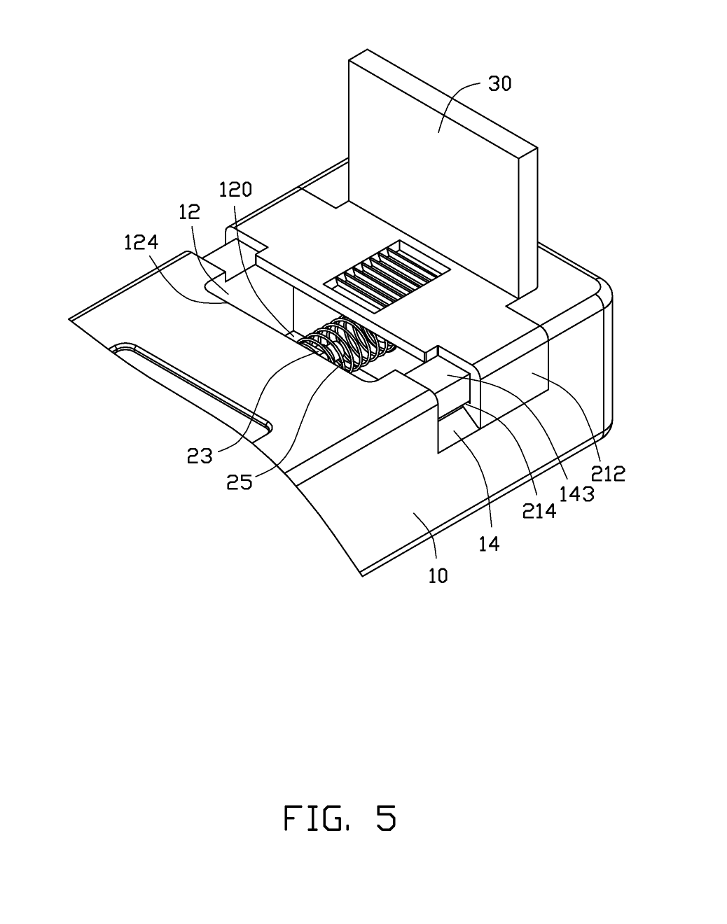

Referring to FIG. 5, in charging the battery 30, the sliding member 21 is slid toward the end wall 124 to deform the spring 25, until the pole 222 pushes the trigger 232 into the head 230 to turn the power off. The battery 30 is then inserted into the receiving room 12 to electrically contact the pins 114 connected to the connecting portions 110. The battery 30 contacts the end wall 122. The siding member 21 is then slid toward the end wall 124 again, and the trigger 232 is pushed by the pole 222 again and is extended out of the head 230 to turn the power on. The sliding member 21 is then released. The spring 25 is restored to push the main portion 210 toward the end wall 122 to sandwich the battery 30 together with the end wall 122.

In charging another battery having a different size from the battery 30, the insulation portions 116 are rotated in the corresponding slots 126 to move the corresponding pins 114 to be electrically connected to the corresponding battery.

In another embodiment, the trigger 232 can be pushed into the head 230 to turn the power on, and be pushed again to extend out of the head 230 to turn the power off.

It is believed that the present embodiments and their advantages will be understood from the foregoing description, and various changes may be made thereto without departing from the spirit and scope of the description or sacrificing all of their material advantages, the examples hereinbefore described merely being exemplary embodiments.

What is claimed is:

1. A power strip for charging a battery, comprising:
a main body defining a receiving room bounded by a bottom wall, two opposite sidewalls, a first end wall, and a second end wall opposite to the first end wall;
two connecting portions rotatably mounted to the first end wall, each connecting portion comprising a pin rested on the bottom wall to be electrically connected to the battery;
a switch mounted to the second end wall; and
a sliding member slidably mounted to the main body to sandwich the battery together with the first end wall; wherein the sliding member is operable to slide toward the second end wall to push the switch, thereby turning the power off; and the sliding member is further operable to slide toward the second end wall to push the switch, thereby turning the power on.

2. The power strip of claim 1, wherein two slots are defined in the first end wall, the slots are extended from top to bottom and are extended through the bottom wall, the connecting portions are rotatably received in the slots.

3. The power strip of claim 2, wherein each connecting portion further comprises an insulation portion mounted to a top end of the connecting portion to rotate the connecting portion, thereby pivoting the corresponding pin.

4. The power strip of claim 1, further comprising a spring sandwiched between the second end wall and the sliding member, wherein the spring comprises a first end fitted around the switch.

5. The power strip of claim 4, wherein the sliding member defines a receiving hole having a blind end in a side of the sliding member facing the second end wall, a pole extends out from the blind end of the receiving hole, the spring further comprises a second end opposite to the first end to be fitted around the pole and is received in the receiving hole.

6. The power strip of claim 1, wherein the sidewalls each define an engaging hole in an outer surface, the sliding member comprises a main portion, two arms extending down from opposite ends of the main portion, a projection protrudes from an inner surface of each arm to be slidably engaged in one of the engaging holes.

7. The power strip of claim 6, wherein the sidewalls each define a cutout on a top surface, the sliding member further comprises two extension portions connected between the opposite ends of the main portion and the arms, the extension portions are slidably received in the corresponding cutouts.

8. The power strip of claim 7, wherein the sidewalls each define a recess communicating with the corresponding cutout and the corresponding engaging hole, the recess slidably receives a corresponding one of the arms.

9. The power strip of claim 1, wherein an antiskid portion is formed on the sliding member.
